(19) United States
(12) Patent Application Publication
(10) Pub. No.: US 2012/0242026 A1
(43) Pub. Date: Sep. 27, 2012

(54) ELEVATED SANITARY CUTTING BOARD

(76) Inventor: Thomas E. Black, SR., Chico, CA (US)

(21) Appl. No.: 13/070,399

(22) Filed: Mar. 23, 2011

(51) Int. Cl. B23Q 3/02

(52) U.S. Cl. 269/309

(57) ABSTRACT

A culinary cutting board is disclosed. The cutting board improves sanitation and reduces physical space needed in food preparation. The non-porous cutting board includes a top piece and two identical and interchangeable leg pieces, which when attached to the top piece, elevate and tilt the cutting board. The tilt is such that grooves in the top piece facilitate the easy removal of juices into a collection device that fits under the elevated top piece and between the leg pieces, thereby saving physical space. The leg pieces can be disengaged from the top piece and all of the pieces can be cleaned in a high temperature washing system. The combination of elevation, tilt, and disengageable leg pieces makes for a cutting board with improved sanitation.

### CROSS-REFERENCE TO RELATED APPLICATIONS

1. Field of the Invention

The present invention is generally related to the field of culinary cutting boards and more particularly to culinary cutting boards with improved sanitation and reduced physical space.

2. Description of the Related Art

Today's culinary cutting boards suffer from a number of disadvantages with respect to juice removal, physical space, and sanitation. Boards that lay flat do not take advantage of gravity to assist in the removal of juices and such boards with grooves can fill up with juices, which overflow onto the counter top or floor, creating an unsanitary condition and a safety hazard. Boards that can be manually elevated do not control the angle at which the board can be tilted, thereby leading to accidents in which the food items as well as the juices run off the board onto unsanitary surfaces.

The physical space occupied by today's cutting boards is a disadvantage. Flat boards take up valuable counter space, which is at a premium in smaller homes, mobile homes, apartments, and the like. It would be desirable to have a cutting board that makes better use of limited counter space.

Lack of sanitation is a disadvantage of current cutting boards. There are several aspects regarding sanitation that come into place. First, many cutting boards are made of wood or bamboo, which is not sanitary as these materials are porous and can harbor bacteria and moisture. Second, many cutting boards have a configuration that cannot be thoroughly sanitized in an industrial setting, i.e., in a commercial dishwasher. Third, many cutting boards require the use of hands to transfer food from the cutting board to a serving dish or cooking item. This transfer is unsanitary. It is desirable to have a cutting board that thoroughly eliminates these risks.

### BRIEF SUMMARY OF THE INVENTION

The present invention provides for juice removal without manual intervention, makes better use of physical space, and removes the common sanitation risks involved with the use of cutting boards. The present invention is a cutting board unit includes a top piece and a pair of leg pieces formed from a non-porous, sanitary material, such as a food grade polymer material. The leg pieces are removably affixed to the top piece so as to elevate and tilt the cutting board to a fixed and precise angle. The elevation and size of the cutting board are sufficient to permit the placement of a pan, plate, or other collection device under the cutting board and between the leg pieces. The top piece includes a pair of grooves that are designed to capture and guide removal of juices from the cutting board towards the front of the unit and into the collection device without the wicking of juices to the underside of the top surface and without risk of the food items rolling or sliding off of the top piece. Furthermore, the angle is such that movement of food items on the top surface to the collection device is easily effectuated by use of a sanitary utensil. The leg pieces connect to the top piece in a manner that makes the cutting board unit very stable but permits their quick and easy removal. The removal of the leg pieces allows the entire unit, the top piece and leg pieces, to be cleaned in a high-temperature commercial washer, thereby mitigating or eliminating any sanitation risk associated with a multiple-piece cutting board unit.

One embodiment of the present invention is a cutting board unit that includes a top piece and a pair of leg pieces. The top piece has a top surface and a bottom surface, a first and a second groove, and a first and second pair of mortises. The first groove and the second groove run parallel for a distance and then angle towards each other and towards a front of the unit. Each of the first pair and second pair of mortises is aligned with an edge of the top piece and includes a first mortise having a first length and a second mortise having a second length, where the first length is longer than the second length. Each leg piece has a pair of tenons, wherein a first of the pair of tenons has a first length and a second of the pair of tenons has a second length. The first length is longer than the second length such that the pair tenons of each leg piece fit into the pair of mortises in the top piece in only one way so as to impart a fixed tilt of the top piece towards the front of the unit. The fixed tilt is sufficient to permit the runoff of any juices on the top piece, including those captured by the grooves, while preventing juices from wicking to the bottom surface of the top piece and preventing foodstuffs from sliding or rolling off the top surface of the top piece.

Thus, the present invention provides for juice removal due to its elevation and size, which permits placement of a collection device under the top piece. The present invention makes better use of physical space because it permits the collection device to be under the cutting board, instead of being off to the side, taking up valuable counter space. The present invention improves sanitation because it is made of a non-porous material, permits the easy removal of juices and food from the top surface, and cleaning of all pieces in a high-temperature commercial washer.

### BRIEF DESCRIPTION OF THE DRAWINGS

These and other features, aspects and advantages of the present invention will become better understood with regard to the following description, appended claims, and accompanying drawings where:

FIG. 1 shows an isometric view of an embodiment of the present invention;

FIG. 2 includes a top view, a front view, a left and right view of the legs, and a bottom view of an embodiment of the present invention;

FIG. 3 shows a detail of the top view of an embodiment of the present invention; and

FIG. 4 shows a detail of the legs in accordance with an embodiment of the present invention.

### DETAILED DESCRIPTION OF THE INVENTION

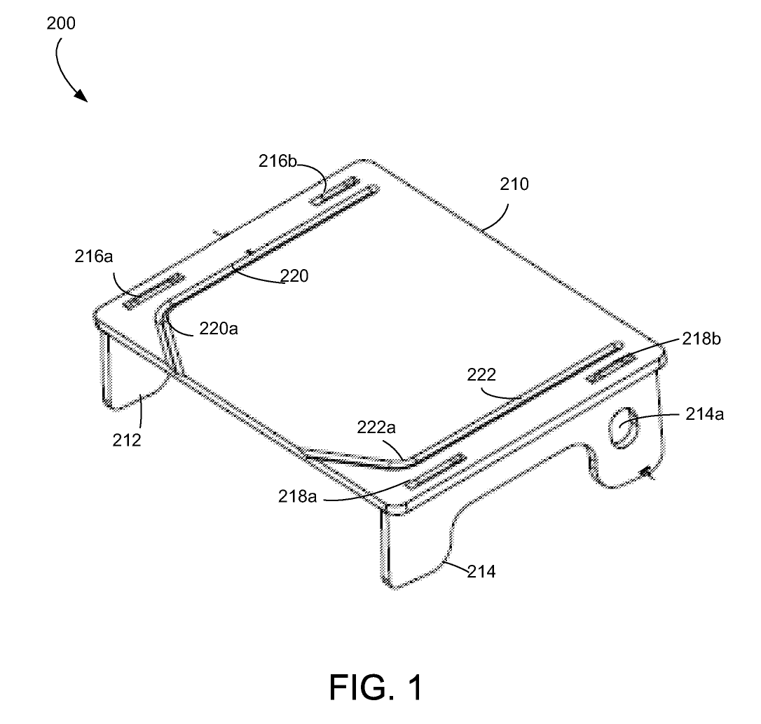

FIG. 1 shows an isometric view 200 of an embodiment of the present invention. The embodiment is a unit having three parts, a top piece 210 and two identical and interchangeable leg pieces 212, 214. The top piece 210 includes four slots, two 216a, b on the left side and two 218a, b on the right side, into which the leg pieces 212, 214 respectively engage. Each of the four slots 216a, 216b, 218a, 218b forms the mortise part of a mortise and tenon joint. The top piece 210 also includes a left groove 220 and a right groove 222. The left groove 220 is adjacent and towards the inside of the left side slots 216a, 216b. This groove 220 has a track that includes a left-to-right turn 220a. The right groove 222 is adjacent and towards the inside of the right side slots 218a, 218b. This groove 222 has a track that includes a right-to-left turn 222a. In this description, the front of the unit is the side towards which the left groove 220 and right groove 222 tend to converge after their turns 220a 222a. The design of the grooves 220 222 is such as to act as a barrier that helps assure that juices on the top piece flow towards the front of the unit. That is, juices flowing generally towards the left or right side of the unit are captured by the grooves to flow towards the front of the unit and juices flowing between the grooves flow towards the front of the unit.

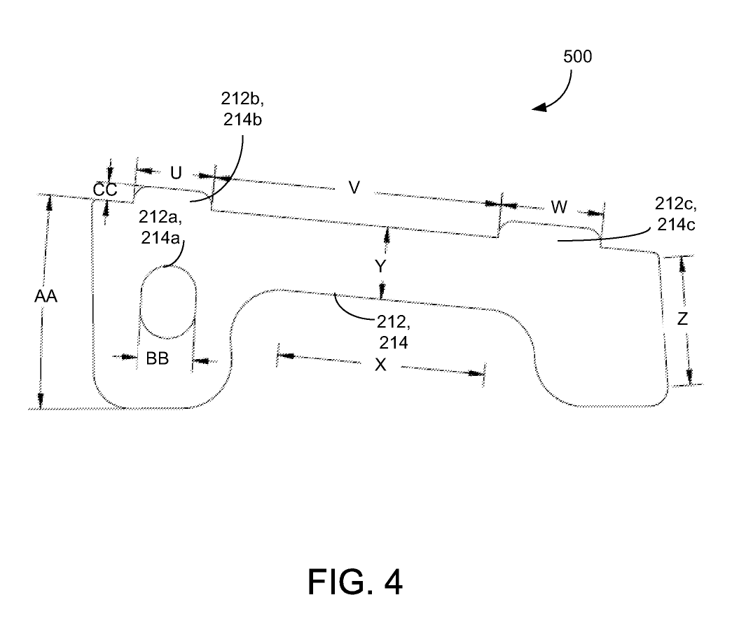

Each of the leg pieces 212, 214 is formed from a single piece of material, which may or may not be the same material used for the top piece, and has a pair of tenons (shown in FIG. 4) for fitting into the mortises 216a, 216b, 218a, 218b on the top piece 210. The tenons are such that only one physical arrangement of the leg pieces 212, 214 will permit the mortise and tenon joint to be formed. In one embodiment, the permissible arrangement is such that the portion of the leg with a hole 218c therein is located distally from the turns 220a, 222a of the grooves 220, 222 on the top piece 210. In one embodiment, the leg pieces are formed from the same material as the top piece. In another embodiment, the leg pieces are made from a different material as the top piece. The different material may be a composite material. In one embodiment, an anti-slip material is added to the bottom of the leg pieces to prevent the legs from sliding. The anti-slip material may comprise rubber mounts affixed to the bottom of the legs.

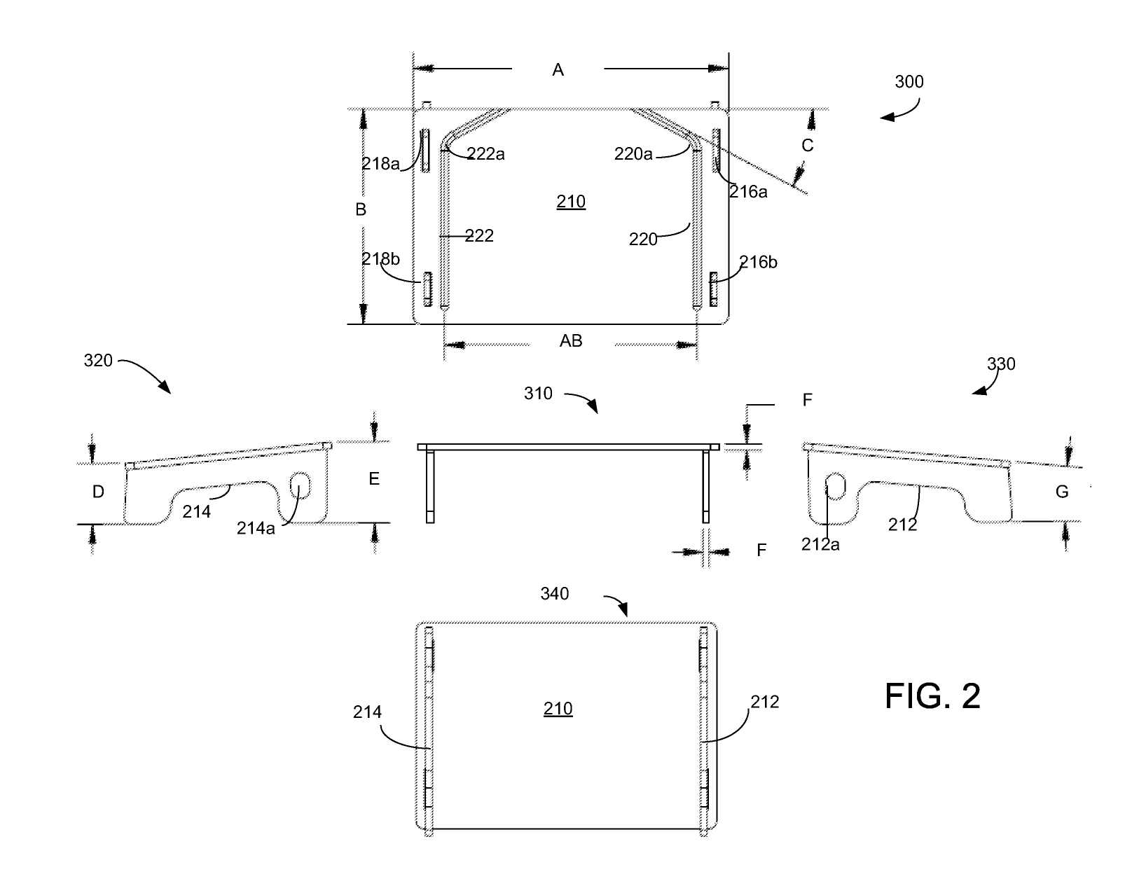

FIG. 2 includes a top view 300, a front view 310, a left view 320 and right view 330 of the leg pieces, and a bottom view 340 of an embodiment of the present invention. FIG. 2 shows the dimensions A and B in the top view 300 and the angle of the turn of the grooves. In one embodiment, dimension A is 17.5 inches and dimension B is 12.00 inches. In this embodiment, the distance AB between the parallel portions of the grooves is 14.00 inches and the angle C of turn of the grooves is 28.09 degrees. In another embodiment, dimension A is 23.375 inches and dimension B is 12.00 inches. The larger A dimension permits the user of large collection devices, such as plates or pans, to be placed under the top piece and between the leg pieces.

FIG. 2 shows the dimensions of the leg pieces 212 214. In one embodiment, the height D of portion of the leg piece that is proximal to the turn of the grooves is 3.52 inches and the height E of the portion of the leg piece that is distal to the turn of the grooves is 4.718 inches. This difference in heights between the proximal and distal portions of the leg pieces 212 214 causes the top piece 210, when connected to the leg pieces 212, 214 and placed on a horizontal surface, to have a pitch or tilt of between 4 to 6 degrees, and preferably 5.73 degrees (dimension G) to the surface. This pitch permits any liquids on the surface captured by the grooves to run towards the turn of the grooves and off the front of the unit into the collection device. Importantly, the pitch or tilt angle G is carefully set so that the liquids running in the grooves 220, 222 at the front of the unit do not wick along the underside of the top surface, while making it highly unlikely that any foodstuffs on the surface of the top piece 210 will roll or slide off.

FIG. 2 also shows dimensions F for the thickness of the material used for the top and leg pieces. In one embodiment, the thickness F is 0.375 inches. In other embodiments, the thickness is 0.500 inches. In the other embodiment, dimension CC of the tenons is 0.498 inches and dimension L is 0.500 inches, with a corresponding thickness of 0.500 inches for the tenons.

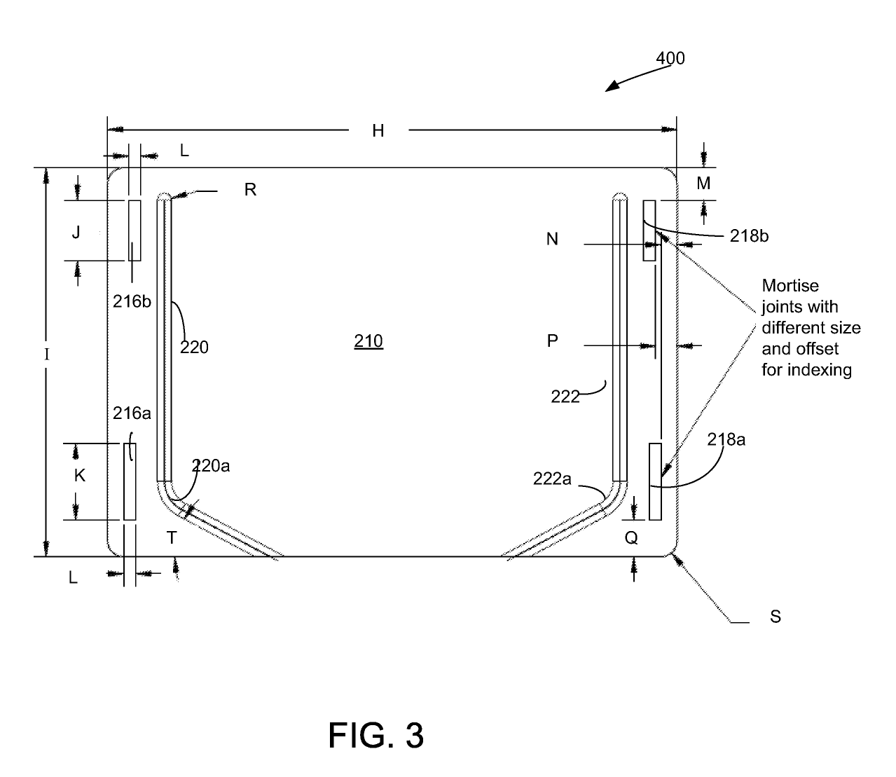

FIG. 3 shows a detail of the top view 400 of an embodiment of the present invention. The top view 400 in FIG. 3 includes dimensions J, K, L, M, N, P, and Q for the mortises 216a, 216b, 218a, 218b. In one embodiment, dimensions J and K are 1.875 and 2.375 inches, respectively. The difference between these two dimensions allows only one way to connect a leg piece to the top piece, as the larger tenon of a leg piece 212, 214 will not fit in the smaller mortise. In the embodiment shown, dimension L is 0.370 inches. In the embodiment shown, dimension M is 1.00 inches. In the embodiment shown, dimensions N and P are 0.494 and 0.653 inches, respectively. The difference between these two dimensions requires that a leg piece must be slightly flexed (bowed) to align the tenons with their respective mortises. The flexed leg piece 212, 214 causes a compression between one side of a tenon and its respective mortise, thereby assuring a snug fit and preventing the leg pieces from falling out of the top piece. The flexed leg piece 212, 214 also means that no latching system is needed to hold the leg piece in place, while at the same time making the leg piece easy to disengage from the top piece. It should be noted that after a long time, a flexed leg piece 212, 214 might not provide a sufficient amount of compression to maintain a snug fit. If this occurs, the leg pieces can be swapped left for right, as the pieces are interchangeable. This will cause the flex of the leg piece to occur in the opposite direction, thereby maintaining a snug fit.

The top view in FIG. 3 further includes dimensions R and T for the grooves 220 222. In one embodiment, dimension R is a radius of 0.217 inches and dimension T is 28 degrees. The depth of the groove is preferably 0.095 inches. The top view in FIG. 3 further includes dimensions H, I, and S for the outside dimensions of the top piece. In one embodiment, dimension H is 17.50 inches and dimension I is 12.00 inches. In one embodiment, dimension S is a radius of 0.500 inches.

FIG. 4 shows a detail 500 of the legs 212, 214 in accordance with an embodiment of the present invention. FIG. 4 includes dimensions U, V, W, and CC for the tenons 212b, 214b, 212c, 214c. In one embodiment, dimensions U and W are 1.61 and 2.11 inches, respectively. As mentioned above, this difference in the size of the tenons 212b, 214b vs. 212c, 214c prevents the incorrect engagement of the legs 212, 214 to the top piece, while still permitting the swapping of the left and right leg pieces. In the embodiment shown, dimension V is 5.90 inches. In the embodiment shown, dimension CC is 0.37 inches, which is sufficiently deep to permit the engagement of the tenon 212b, 214b, 212c, 214c with the mortise 216b, 216a, 218b, 218a without protruding above the top surface of the top piece 210, when the top piece 210 has a thickness of 0.375 inches. In another embodiment, the top piece has a thickness of 0.500 inches.

FIG. 4 further includes dimensions Z and AA for the height and angle of the leg piece 212 214. In one embodiment, dimension Z is 2.65 inches and dimension AA is 5.7 degrees. These dimensions ensure that the angle of 4 to 6 degrees and preferably of 5.7 degrees with a horizontal surface is met.

FIG. 4 further includes dimensions X, Y for the length and width of portions of the leg piece 212 214. In one embodiment, dimension X is 4.25 inches and Y is 1.49 inches. These dimensions insure that a leg piece 212 214 has sufficient material throughout its length to create a solid structure, but still permit the flexure needed to maintain the mortise 218b, 218a, 216b, 216a and tenon joints 212b, 214b, 212c, 214c under compression.

FIG. 4 further includes dimension BB for the hole 212a, 214a in the leg piece 212, 214. In one embodiment, dimension BB is 1.13 inches for the width of a slot sufficient for the insertion of a finger to help engage or disengage a leg piece 212 214 from the top piece 210. In all figures, the edges of all pieces are preferably chamfered to remove any sharp edges. In one embodiment, the length of the chamfer is preferably 0.06 inches and the chamfer is preferably at a 45-degree angle. In the embodiment, the chamfer on the tenons aids the engagement of the tenons 212b, 214b, 212c 214c with the mortises 218b, 218a, 216b, 218a, by acting as a ramp to guide the tenon into the mortise. In all figures, the tolerance on linear dimensions is +−0.015 to 0.030.

Although the present invention has been described in considerable detail with reference to certain preferred versions thereof, other versions are possible. Therefore, the spirit and scope of the appended claims should not be limited to the description of the preferred versions contained herein.

What is claimed is:

1. A cutting board unit comprising:
a top piece having a top surface and a bottom surface, a first and a second groove, and a first and second pair of mortises, said first groove and said second groove running parallel for a distance and then angling towards each other and towards a front of the unit,
wherein each of said first pair and second pair of mortises is aligned with an edge of the top piece and includes a first mortise having a first length and a second mortise having a second length,
wherein first length is longer than the second length; and
a first leg piece and a second leg piece,
wherein each leg piece has a pair of tenons, a first of the pair of tenons having a first length, a second of the pair of tenons having a second length,
wherein the first length is longer than the second length such that the pair tenons of each leg piece fit into the pair of mortises in the top piece in only one way so as to impart a fixed tilt of the top piece towards the front of the unit.

2. The cutting board unit according to claim 1, wherein the fixed tilt is sufficient to permit the runoff of any juices on the top surface towards the front of the unit, including those captured by the grooves, while preventing the juices from wicking to the bottom surface of the top piece and preventing foodstuffs from sliding or rolling off the top surface of the top piece.

3. The cutting board unit according to claim 2, wherein the fixed tilt is approximately 5.7 degrees with respect to a horizontal surface.

4. The cutting board unit according to claim 1,
wherein the first and second mortises of each pair of mortises have different offsets from an edge of the top piece; and
wherein each of the first and second leg pieces is slightly flexed to allow the first and second tenons to compressively and removably engage the first and second mortises.

5. The cutting board unit according to claim 1, wherein the top piece and the first and second leg pieces are made from the same material.

6. The cutting board unit according to claim 5, wherein said material is a non-porous material that does not harbor bacteria, odors, or moisture.

7. The cutting board unit according to claim 1, wherein each of the leg pieces includes a hole proximate to the smaller tenon to aid in the disengaging of the tenons of a leg piece from the mortises with which said tenons are engaged.

8. The cutting board unit according to claim 1, wherein each tenon is chamfered to create a ramp that eases the engagement of the tenon into a respective mortise.

9. The cutting board unit according to claim 1, wherein the first leg piece is swappable with the second leg piece and vice-versa.

10. The cutting board unit according to claim 1, wherein the first and second leg pieces are of a material that is different from the material of the top piece.

11. The cutting board unit according to claim 1, where the first and second leg pieces include an anti-skid material.
